(19) United States
(12) Patent Application Publication
(10) Pub. No.: US 2015/0106453 A1
(43) Pub. Date: Apr. 16, 2015

(54) SERVER DEVICE AND DISPLAY APPARATUS PROVIDING DONATION SERVICE, AND METHOD FOR PROVIDING SERVICE THEREOF

(71) Applicant: SAMSUNG ELECTRONICS CO., LTD., Suwon-si (KR)

(72) Inventors: In-ji KIM, Uijeongbu-si (KR); Young-jun RYU, Suwon-si (KR); Sang-on CHOI, Suwon-si (KR)

(73) Assignee: SAMSUNG ELECTRONICS CO., LTD., Suwon-si (KR)

(21) Appl. No.: 14/336,086

(22) Filed: Jul. 21, 2014

(30) Foreign Application Priority Data
Oct. 14, 2013 (KR) 10-2013-0122138

(51) Int. Cl. H04L 12/58

(52) U.S. Cl. CPC H04L 51/24
USPC 709/206

(57) ABSTRACT

A method for providing a service of a server device is provided. The method includes selecting a donor from among users registered in the server device; selecting a recipient; and in response to the donor and the recipient being selected, providing the donor with a notification message indicating that a donation service is provided to the recipient in the name of the donor. Accordingly, user satisfaction can be improved.

### RELATED APPLICATION

This application claims priority from Korean Patent Application No. 10-2013-0122138 filed on Oct. 14, 2013, in the Korean Intellectual Property Office, the disclosure of which is incorporated herein by reference in its entirety.

### BACKGROUND

1. Field

Apparatuses and methods consistent with exemplary embodiments relate to a server device, a display apparatus, and a method for providing a service thereof, and more particularly to a server device providing a donation service in the name of a user of a display apparatus, the display apparatus associated with the server device, and a method for providing a service thereof.

2. Description of the Related Art

With the development of electronic technology, various types of electronic devices have been developed and supplied. For example, display devices, such as televisions (TVs), portable phones, and tablet personal computers (PCs), have been increasingly used in user's daily life.

Such display devices of the related art merely provide functions outputting content so that users can view the output content. Accordingly, many attempts to provide various services through various interactions with users have recently been made.

However, because most services must be initiatively performed by users, that is, instead of being provided to the users, user satisfaction is somewhat lowered in comparison to the quality of services. Further, because such services themselves are mostly focused on user convenience, it is necessary to further diversify the kinds of services.

Accordingly, there is a need for various services that can be provided using a server device.

### SUMMARY

Exemplary embodiments address at least the above problems and/or disadvantages and other disadvantages not described above. However, exemplary embodiments are not required to overcome the disadvantages described above, and an exemplary embodiment may not overcome any of the problems described above.

According to an aspect of an exemplary embodiment, there is provided a method for providing a service of a server device, the method including: selecting a donor from among users registered in the server device; selecting a recipient; and in response to the donor and the recipient being selected, providing the donor with a notification message indicating that a donation service has been provided to the recipient in the name of the donor.

The selecting the donor may include selecting the donor based on a number of points that is calculated for each of the users registered in the server device, based on a usage history of each of the users registered in the server device.

The selecting the donor may further include receiving usage history information from a display apparatus of a user from among the users registered in the server device; calculating the to the number of points based on the received usage history information; and selecting the user as the donor in response to the number of points exceeding a threshold value.

The selecting the donor may further include receiving the number of points calculated by a display apparatus of a user from among the user registered in the server device; and selecting the user as the donor in response to the number of points exceeding a threshold value.

The usage history may include at least one from among display apparatus usage results, usage results of a service provided by the server device, social networking service (SNS) usage results using the display apparatus, login frequency of the display apparatus, and login frequency of the server device.

The selecting the donor may include selecting the donor through a random lottery among the users registered in the server device.

The method for providing a service according to the aspect of the present disclosure may further include requesting the donation service by transmitting information about the recipient and the donor to a donation execution institute.

The method for providing a service according to the aspect of the present disclosure may further include providing the donor with multimedia content of the recipient after a preset time elapses, in response to the donation service being executed.

The selecting the recipient may include: receiving information about the recipient which is input in a display apparatus of the donor; and selecting the recipient based on the information about the recipient.

The selecting the recipient may include randomly selecting the recipient from among pre-registered recipients.

According to an aspect of another exemplary embodiment, there is provided a server device including a communicator configured to perform communication with a display apparatus; a storage configured to register a user of the display apparatus; and a controller configured to select a donor from among users registered in the storage, and transmit, to the display apparatus of the donor, a notification message indicating that a donation service has been provided to a recipient in the name of the donor.

The controller may be further configured to select the donor based on a number of points that are calculated for each of the registered users, based on a usage history of each of the registered users.

In response to usage history information being received from a display apparatus of a user from among the registered users, the controller may be further configured to calculate the number of points based on the received usage history information, and select the user as the donor in response to the number of points exceeding a threshold value.

The controller may be further configured to receive the number of points calculated by a display apparatus a user from among the registered users, and select the user as the donor in response to the number of points exceeding a preset threshold value.

The usage history may include at least one from among display apparatus usage results, usage results of a service provided by the server device, social network service (SNS) usage results using the display apparatus, login frequency of the display apparatus, and login frequency of the server device.

The controller may be further configured to select the donor through a random lottery among the registered users.

The controller may be further configured to select the recipient, and in response to the recipient being selected, the controller may be further configured to request the donation service by transmitting information about the recipient and the donor to a donation execution institute.

In response to the donation service being executed, the controller may be further configured to provide the donor with multimedia content of the recipient after a preset time elapses.

In response to information about the recipient input in a display apparatus of the donor being received, the controller may be further configured to determine the recipient to receive the donation service according to the information about the recipient.

The controller may be further configured to select the recipient by randomly selecting the recipient from among the pre-registered recipients.

According to an aspect of another exemplary embodiment, there is provided a method for selecting a donor and providing a donation to a recipient including: receiving usage history information from a plurality of users registered in the server; determining a number of points for each of the plurality of users, based on the received usage history information of the plurality of users; selecting the donor from among the plurality of users, based on the determined number of points for each of the plurality of users; and providing the donation to the recipient in the name of the donor.

The selecting the donor from among the plurality of users may include: selecting users having at least a certain number of points from among the plurality of users; and selecting the donor from among the selected users.

The recipient may be randomly selected from among pre-registered recipients.

The recipient may be selected by the donor from among pre-registered recipients.

The method may further include providing the donor with a notification message indicating that the donation service has been provided to the recipient in the name of the donor.

The donation may be based on the number of points of the donor.

According to the various exemplary embodiments described above, various services are provided to the user of the display apparatus, and thus the user satisfaction can be improved.

### BRIEF DESCRIPTION OF THE DRAWINGS

The above and/or other aspects will become more apparent by describing certain exemplary embodiments with references to the accompanying drawings, in which:

FIG. 1 is a block diagram illustrating the configuration of a service system according to an exemplary embodiment;

FIG. 2 is a block diagram illustrating the configuration of a server device according to an exemplary embodiment;

FIG. 3 is a flowchart illustrating a method for providing a service of a server device according to an exemplary embodiment;

FIG. 4 is a timing diagram explaining the service providing operation of a service system according to an exemplary embodiment;

FIGS. 5 and 6 are flowcharts illustrating a method for selecting a donor according to various exemplary embodiments;

FIG. 7 is a diagram illustrating examples of information that a display apparatus transmits to a server device;

FIG. 8 is a block diagram illustrating the configuration of a display apparatus according to an exemplary embodiment;

FIG. 9 is a flowchart illustrating a method for providing a service of a display apparatus according to an exemplary embodiment;

FIG. 10 is a diagram illustrating an example of a user registration process;

FIG. 11 is a diagram illustrating an example of a notification message that is displayed on a display apparatus according to an exemplary embodiment;

FIG. 12 is a diagram illustrating another type of a notification message;

FIG. 13 is a diagram explaining the operation of a display apparatus according to an exemplary embodiment in which a recipient can be selected;

FIGS. 14 to 16 are diagrams explaining various methods for selecting a recipient;

FIG. 17 is a diagram illustrating an example of a method for notifying a donor of result of a donation; and

FIG. 18 is a diagram illustrating an example of a donation community.

### DETAILED DESCRIPTION OF EXEMPLARY EMBODIMENTS

Hereinafter, certain exemplary embodiments are described in greater detail with reference to the accompanying drawings.

In the following description, the same drawing reference numerals are used for the same elements, even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

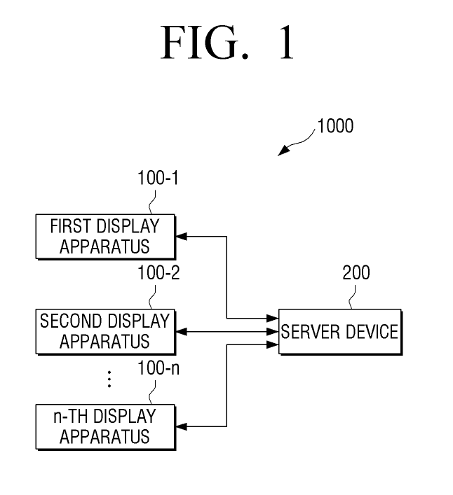

FIG. 1 is a block diagram illustrating the configuration of a service system according to an exemplary embodiment. Referring to FIG. 1, a service system 1000 includes a plurality of display apparatuses 100-1 to 100-n and a server device 200.

For convenience in explanation, FIG. 1 illustrates that the plurality of display apparatuses are divided into first to n-th display apparatuses 100-1 to 100-n, and connect to the server device 200. However, the respective display apparatuses may be independent apparatuses that are used with no relation to each other. Further, the display apparatuses may be manufactured separately from the server device 200, and may perform communication with the server device 200 to construct one service system 1000.

The display apparatuses 100-1 to 100-n may be various types of user terminal devices, such as TVs, mobile phones, tablet PCs, PCs, laptop PCs, digital frames, kiosk, MP3 players, and personal digital assistants (PDAs).

The server device 200 may be implemented as a server device that is operated by a manufacturer that manufactures and sells the plurality of display apparatuses 100-1 to 100-n, but is not limited thereto. For example, the server device 200 may be implemented by various types of server devices, such as a server device that is operated by a manager that makes a separate contract with the corresponding manufacturer, a server device operated by a content producer, a general web server device, and a broadcasting station server device.

In the server device 200, information about the respective display apparatuses 100-1 to 100-n or information about users who use the display apparatuses may be registered. For example, a user may access a web page that is provided by the server device 200 by accessing the server device 200 through the display apparatuses 100-1 to 100-n. On the web page, the user may input various kinds of information related to the user, that is, user information. The display apparatuses 100-1 to 100-n may transmit the input user information to the server device 200 to register the user information.

The server device 200 may select a donor (i.e., donor) among registered users. The donor refers to the nominee of a donation service. The server device 200 may also select a recipient. The donor and the recipient may be selected in various methods according to exemplary embodiments. The selection methods will be described in greater detail below.

If the donor and the recipient are selected, the server device 200 performs a donation service for donation in the donor's name with respect to the recipient. The donation may be performed in various ways.

As an example, the server device 200 may transmit information about the donor and the recipient to at least one donation execution institute to request the donation service. The donation execution institute may transfer cash or goods to the recipient in the donor's name in accordance with the donation service request. For the donation service, an operator of the donation execution institute and an operator of the server device 200 may contract with each other in advance of the donation service. That is, the operator of the server device 200 may provide cash or goods to the donation execution institute in advance, and if the operator of the server device 200 requests the donation execution institute to provide the cash or goods to a desired recipient, the donation execution institute may provide the cash or goods on behalf of the server device 200.

As another example, the server device 200 may request the donation service of transferring cash to a financial account of the donation execution institute using an online account transfer method. In this case, the donation execution institute may transfer the cash to the recipient designated by the server device 200 by an online or offline method.

As still another example, the server device 200 may directly make a donation to the recipient by an online or offline method. The server device 200 may collect information about the recipient through a pre-event. For example, the server device 200 may receive a support request through a home page or the like, or may select recipient candidates through recommendations. In this procedure, the server device 200 may store names, ages, addresses, phone numbers, and back account numbers of the recipient candidates. If an event to execute a donation service occurs, the server device 200 selects the recipient from among the candidates, and may directly execute the donation using the information about the selected recipient.

In addition, the donation service may be performed in various other ways.

If it is determined to execute the donation service, the server device 200 may transmit a notification message to the donor indicating that the donation service is provided in the donor's name. For example, if a first user that uses the first display apparatus 100-1 is selected as a donor, as shown in FIG. 1, the server device 200 may transmit the notification message to the first display apparatus 100-1. The notification message may be provided before or after the donation is completed.

The notification message may be generated as a simple text message, but is not limited thereto. For example, the notification message may be generated as a moving image message or still image message. That is, a moving image or a still image, which is obtained by capturing an image of the situation in which donations or donation goods are directly transferred to the recipient, may be included in the notification message to be provided to the donor. The donor can view the unexpected notification message, and thus the user can feel as if they directly made the donation. Accordingly, the user satisfaction and convenience can be improved.

The server device 200 can perform the donation service whenever a predetermined event occurs. Here, various kinds of events may occur, such as an event in which a preset time period (e.g., the 1st of each month) arrives, an event in which a special day, such as Christmas, a traditional holiday, a national holiday, or an election day, arrives, an event in which a user's memorial day, such as a birthday of the donor or the recipient, a wedding anniversary, a display apparatus purchase day, an employment day, a promotion day, or a liberation day arrives, an event in which an operator of the server device 200 inputs a command for executing a donation, and an event in which a day when a user who is selected as the donor arrives.

Even after the donation service is performed, the server device 200 may continuously manage the donor and the recipient. For example, the server device 200 may create a donation community and may guide the donor and the recipient to join the corresponding community. Accordingly, the server device 200 may guide the donor and the recipient so that the support is not performed only once, but is continuously performed. Exemplary embodiments related to this feature will be described in greater detail below.

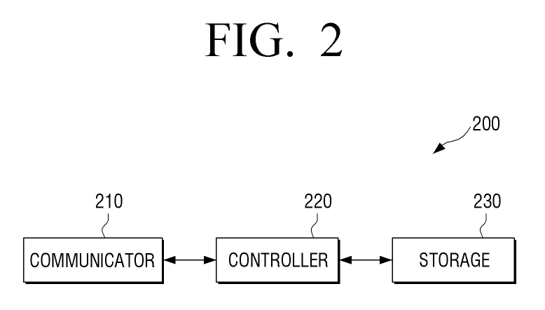

FIG. 2 is a block diagram illustrating the configuration of a server device according to an exemplary embodiment. Referring to FIG. 2, a server device 200 includes a communicator 210, a controller 220, and a storage 230.

The communicator 210 is a component that performs communication with various kinds of external devices (e.g., a display apparatus). The communicator 210 may be connected to the display apparatus 100 through the Internet.

The storage 230 is a component that stores user information transmitted from respective users. The user information stored in the storage 230 may include a user name, birth date, email address, ID, password, photograph, taste, special ability, occupation, anniversary, religion, preferential content, and preferential channel.

If a user transmits a registration request and user information through the display apparatus 100, the controller 220 may allocate an account to the corresponding user and register the allocated account in the storage 230. Thereafter, the user may access the server device 200 and input an ID and a password to access various kinds of information stored in the user's account.

If an event to execute a donation service occurs, the controller 220 selects a donor among users registered in the storage 230. The donor may be selected through various methods. For example, the controller 220 may select the donor according to a random lottery method, a point calculation method, a direct input method, etc. Methods for selecting the donor will be described in greater detail below.

Further, the controller 220 may also determine a recipient using various methods.

For example, the controller 220 may receive support requests or recommendations through a home page that is operated by the server device 200, as described above, or a home page that is operated by a party that is associated with the server device 200. The controller 220 may determine recipients through a random lottery among persons who have requested or who have been recommended. Further, the controller 220 may determine recipients in the order of their recommendation frequency.

As another example, the controller 220 may provide an opportunity to a user who wins a prize as a donor to select a recipient. In this case, the donor can directly select the recipient, and thus can feel satisfaction as if they directly made the donation.

As another example, the controller 220 may select a person who is directly selected by an operator of the server device 200 as a recipient. That is, the operator of the server device 200 may optionally select a person as a recipient.

On the other hand, the support amount of money or support goods may be prepared using various methods.

As an example, an operator of the server device 200 may prepare the support amount or support goods through self-supply of expenses.

Further, the operator of the server device 200 may be provided with a portion of earnings that are generated due to sales or use of the display apparatus 100 based on an agreement with the manufacturer of the display apparatus 100.

Further, the user of the display apparatus 100 may download multimedia content or applications from various kinds of content providing sources. In this case, a fee may be charged to the user to download multimedia the content or applications. The operator of the server device 200 may collect part of the cost that is paid by the user as points through an agreement with the operator of the content providing sources. Accordingly, cash or goods may be acquired using the saved points. In addition, financial resources may be provided through an agreement with an operator operating an SNS server or other parties.

If the donor and the recipient are selected, the controller 220 transmits, to the display apparatus 100 of the donor, a notification message indicating that a donation service is provided in the donor's name. Accordingly, the user who is selected as the donor may feel an overflowing joy as if the user directly made a donation.

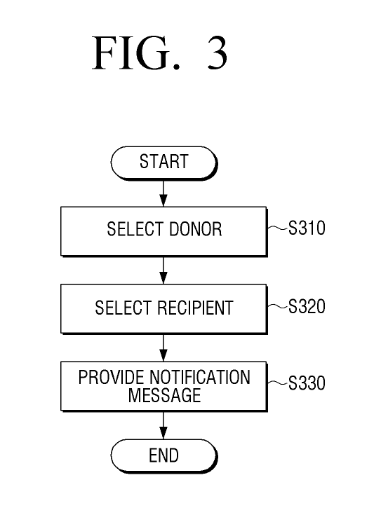

FIG. 3 is a flowchart illustrating a method for providing a service of a server device according to an exemplary embodiment. Referring to FIG. 3, the server device 200 may select a donor among users registered in the server device (S310).

Separately from the donor selection, the server device 200 may select a recipient (S320). As described above, the selection of the donor and the recipient may be implemented in various manners. FIG. 3 illustrates that the selection of the donor is performed prior to the selection of the recipient, but is not limited thereto. That is, the donation service may be executed through selection of the donor whenever various events as described occur and where the recipient is pre-selected.

If the donor is selected, the server device 200 provides a notification message to the donor notifying the donor that a donation service is provided in the donor's name (S330). The notification message may be provided not only as a simple text message, but also in various other types of messages, such as a moving image message, a still image message, an audio message, and an icon.

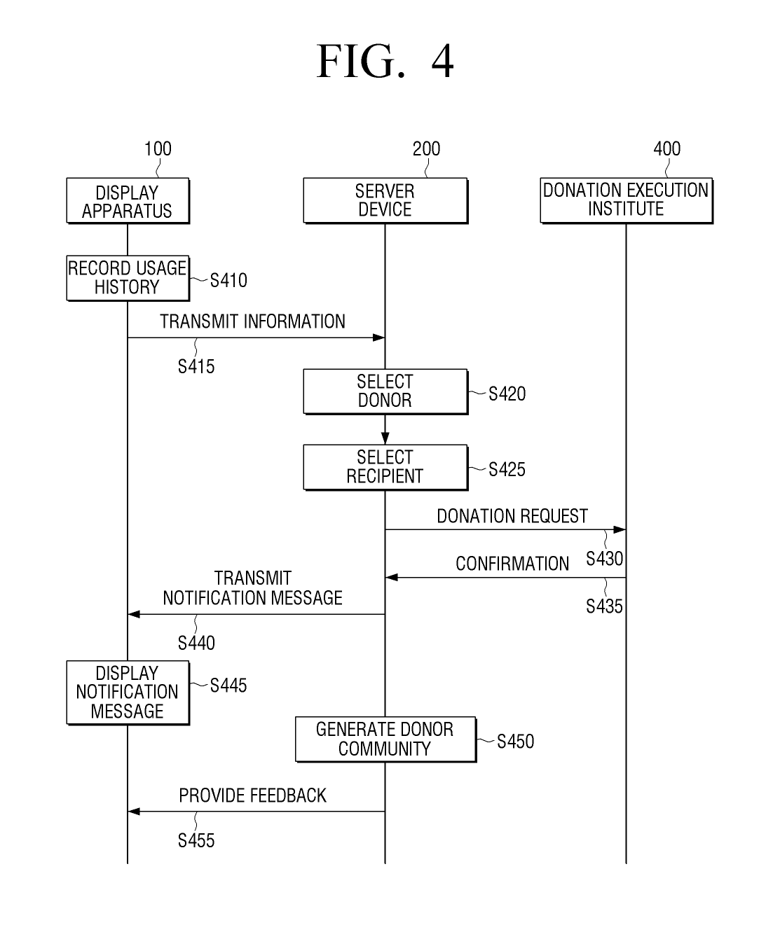

FIG. 4 is a diagram explaining the service providing operation of a service system according to an exemplary embodiment. Referring to FIG. 4, the display apparatus 100 records information about the user's usage history of the display apparatus 100 (S410). Accordingly, the display apparatus 100 may provide the recorded information to the server device 200 periodically or at a specific time (S415).

The server device 200 may select the donor (S420) and the recipient (S425) based on the registered user information.

If the donor and the recipient are selected, the server device 200 requests a donation service through transmission of information about the donor and the recipient to a donation execution institute 400 (S430).

The donation execution institute 400 may be a server device or a terminal apparatus that is operated by various institutes, such as, a charitable institution, a bank, a national institute, a school, an orphanage, and an asylum for the elderly. Since various examples of the detailed donation method have been described, the duplicate explanation thereof will be omitted. The donation execution institute 400 executes the donation in response to a donation request, and then may send a confirmation message to the server device 200.

If the donation is completed, the server device 200 transmits, to the display apparatus 100 of the donor, a notification message notifying the donor that the donation has been performed in the donor's name (S440). FIG. 4 illustrates that the notification message is transmitted after the donation is executed. However, the notification message transmission time may be changed. That is, if the donor is determined, the notification message may be immediately transmitted to the display apparatus 100 of the donor before the donation is executed.

If the notification message is received, the display apparatus 100 displays the notification message (S445). Further, the server device 200 may generate a donation community by online (S450), and may officially announce the donation service contents for the donor and the recipient. Thereafter, if the recipient leaves a message in response to the donation service or performs community activity, the server device 200 may provide feedback of the contents to the donor (S455). Specifically, the server device 200 may provide a moving image of the recipient to the donor. This may increase ongoing curiosity and donations.

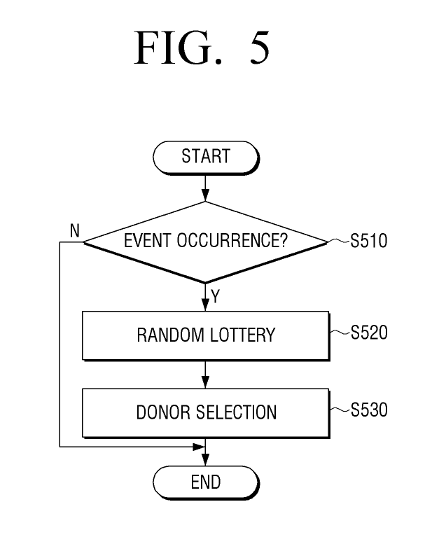

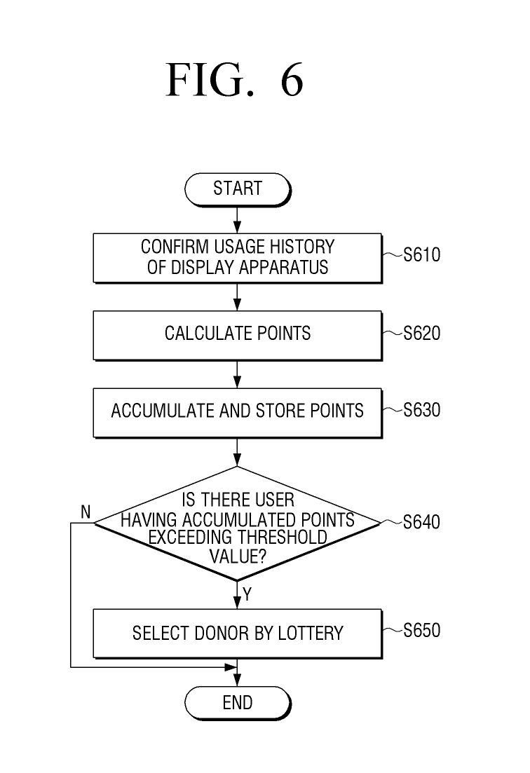

FIGS. 5 and 6 are flowcharts illustrating a method for selecting a donor according to various exemplary embodiments.

First, FIG. 5 is a flowchart illustrating a method for selecting a donor according to a random lottery method. Referring to FIG. 5, the controller 220 may select the donor through a random lottery among the registered users.

Specifically, if a preset event occurs (S510), the controller 220 of the server device holds a random lottery (S520). The controller 220 sorts the registered users in the order of their registration, and generates a random value using a random value generation program. If the random value is generated, the controller 220 may determine the user that corresponds to the random value as a donor (S530).

The random lottery may be performed in various ways. That is, the registered users may be classified into a plurality of categories, and a random lottery may be held in each of the categories. For example, the users are classified into various categories, such as a user group including users who purchase a large amount of paid content, a user group including users who purchase a large amount of paid applications, a user group including users who use free services, and a user group including users having low display apparatus usage results, and the random lottery may be held in each of the categories. In this case, the number of lotteries, the number of donors, and the support amount may be differently set by categories. For example, with respect to the user group including users who purchase a large amount of paid content or paid applications, the lottery may be held more frequently so as to select a large number of donors, while with respect to the user group including users having low display apparatus usage results, the number of lotteries and the number of donors may be set to relatively small.

Further, the support amount or the support goods may be consistently determined or may be differently determined depending on the points collected by corresponding users. The points may be calculated according to the user's usage history and may be accumulatively recorded in the storage 230.

The usage history may include at least one of display apparatus usage results, usage results of a service provided by the server device, Social Network Service (SNS) usage results using the display apparatus, login frequency of the display apparatus, and login frequency of the server device. The points may be directly calculated by the controller 220 of the server device, or may be calculated and transmitted by the respective display apparatuses. In the case where the points are directly calculated by the controller 220 of the server device 200, the respective display apparatus may transmit the user state information at any time. The controller 220 may donate the amount of money that is in proportion to the points owned by the donor or goods that correspond to the amount of money.

FIG. 6 is a flowchart illustrating a method for selecting a donor according to a point calculation method. Referring to FIG. 6, the controller 220 confirms the usage history of the display apparatus (S610), and calculates the points according to the usage history (S620).

The usage history may be confirmed through information that is transmitted from the display apparatus 100. Further, the points may be calculated based on various kinds of usage history information as described above, and may be accumulatively managed and stored (S630).

FIG. 6 illustrates that the server device 100 calculates the points. However, the display apparatus 100 itself may also calculate the points and transmit the calculated points to the server device 200.

Further, the points may be calculated with respect to the display apparatuses, or may be calculated in the unit of users who use the display apparatuses. That is, if there are a plurality of users, the respective users may login the display apparatuses using their own IDs to use the display apparatuses. Accordingly, the display apparatus 100 may calculate the points in consideration of the usage history by IDs of the users and may be accumulatively managed. Further, the server device 200 may select a donor based on the points calculated by users of the display apparatuses.

As a result, high points may be accumulated with respect to a user who frequently views the display apparatus, a user who uses various services by frequently accessing the server device, a user who frequently uses the SNS service, or a user who frequently logs into the display apparatus 100 or the server device 200. As described above, in the case where the usage history is divided into various items, the points may be calculated with different weight values for the respective items.

The controller 220 may select a donor based on the points. Referring to FIG. 6, the controller 220 may determine whether there is a user having a number of the accumulated points that exceeds a threshold value (S640). As the result of the determination, if a large number of users having a number of the points that exceed the preset threshold value are present, the controller 220 may select a donor by lottery among the users (S650).

Further, although not illustrated in FIG. 6, the controller 220 may also select all the users having the number of the points that exceed the threshold value as donors. For example, if the threshold value is set to ten thousand points, when a donation event occurs, the controller 220 may select all the users who have acquired at least ten thousand points as donors. In this case, the support amount or support goods may be equally set with respect to the respective donors.

Further, although not illustrated in FIG. 6, the controller 220 may also arrange the users based on their respective calculated point levels, and select users as donors based on their respective calculated point levels. For example, if users 1 to 10 are present in the order of their point level and three of them can be selected as donors, the controller 220 selects users 1 to 3 as donors.

According to this method, the probability of winning is increased as the display apparatus 100 or the server device 200 is used more frequently. Accordingly, the user may have stronger desire to use the display apparatus 100 or the server device 200 more frequently.

Conversely, the controller 220 may also select donors from among users having low points. That is, in the above-described example, the controller 220 may select users 8 to 10 as event winners. In this case, the users who do not frequently use the display apparatus 100 or the server device 200 can be encouraged to use the display apparatus 100 or the server device 200 more frequently.

In addition, the controller 220 may select donors based on donor information that is input by an operator of the server device 200. That is, the operator may determine a donor through an offline lottery or subjectively, and may input the donor information to the server device 200 through an input means.

As described above, the donors may be determined in various ways.

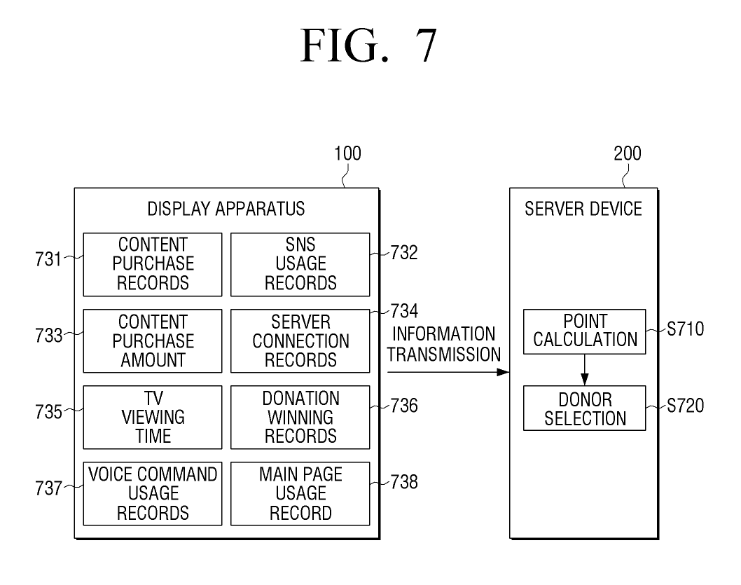

FIG. 7 is a diagram illustrating examples of information that a display apparatus 100 transmits to a server device 200.

As illustrated in FIG. 7, the display apparatus 100 records various kinds of information 731 to 738 according to a user's use of the display apparatus 100. Specifically, various kinds of usage history information, such as content purchase records 731, SNS usage records 732, content purchase amount 733, server connection records 734, TV viewing time 735, donation winning records 736, voice command usage records 737, and main page usage records 738, may be recorded.

If a determined time period arrives or a user command is input, the display apparatus 100 transmits the recorded usage history information to the server device 200.

The server device 200 may calculate the points based on the transmitted information (S710). For example, if it is set to give one point for each hour of TV viewing and to give one point for each content purchase amount of 1 dollar, 13 points would calculated for a 10 dollar purchase of content and for three-hours of TV viewing thereof. The server device 200 accumulatively records the calculated points in an account that is allocated to the user of the corresponding display apparatus 100.

The server device 200 may monitor the accumulatively recorded points at any time, and may select the user of the corresponding display apparatus 100 as a donor if the number of monitored points exceeds the threshold value (S720). In this case, the donors may be automatically selected if the number of points exceeds the threshold value, and then may be selected again by random lottery or in the order of their points.

As described above, the server device 200 can provide various types of donation services. In the above-described exemplary embodiments, explanation has been made based on the donation service. However, the server device 200 can provide various services in addition to the donation service.

For example, the server device 200 may prepare a specific event, and may select an event winner in various methods, such as a random lottery method, a point calculation method, and a direct input method. Accordingly, the server device 200 can provide the event winner with various services, such as a content providing service to transmit multimedia content or applications, a service to deduct or exempt a paid service use amount, and a service to extend a service providing period. Particularly, in the case of a point calculation method, the server device 200 may provide, to the event winner, content or applications having a value that corresponds to the number of points of the event winner or may provide a cash back service that deducts the points owned by the event winner from the amount used.

Further, when providing a notification message to a user selected a donor, the server device 200 may provide an opportunity for the user to select whether to use a donation service for executing a donation in the user's name or to get an another service for themselves. If the user selects to use the donation service, the display apparatus 100 notifies the server device 200 to execute the donation service. In contrast, if the user selects another service, such as a content providing service or amount deduction service, the server device 200 may directly provide the service selected by the user to the display apparatus 100.

The display apparatus 100 may be implemented by various types of devices as described above.

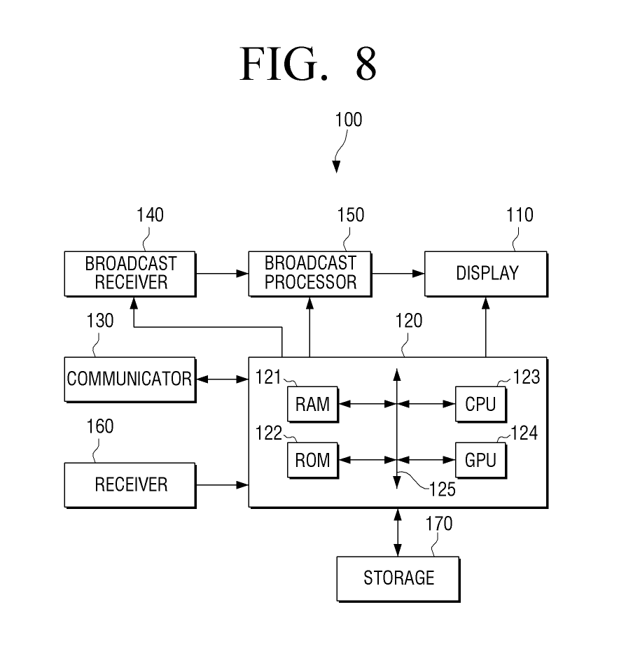

FIG. 8 is a block diagram illustrating the configuration of a display apparatus according to an exemplary embodiment. FIG. 8 shows a display apparatus 100 that is implemented by a broadcast receiving apparatus. Referring to FIG. 8, the display apparatus 100 includes a display 110, a controller 120, a communicator 130, a broadcast receiver 140, a broadcast processor 150, a receiver 160, and a storage 170.

The display 110 is a component that displays content. The content may be provided from various sources. For example, broadcasting content that is received through a broadcasting channel, content that is received from an IP server through an IP network, or content that is reproduced by a recording medium reproduction device may be displayed on the display 110.

The communicator 130 is a component that performs communication with the server device 200. Specifically, the communicator 130 may transmit usage history information that is stored in the storage 170 to the server device 200. Further, the communicator 130 may receive various kinds of notification messages from the server device 200.

The broadcast receiver 140 is a component that selects a broadcasting channel and receives content through the selected broadcasting channel. Further, the broadcast processor 150 is a component that processes the content received through the broadcast receiver 140 and extracts video and audio data.

The broadcast receiver 140 and the broadcast processor 150 may have different configurations according to the broadcasting communication standards adopted in a country in which the display apparatus 100 is used. The various digital broadcasting standards may include standards, such as ATSC (Advanced Television System Committee), DVB (Digital Video Broadcasting), and ISDB-T (Integrated Services Digital Broadcasting-Terrestrial). In the case where the ATSC standard is adopted, the broadcast receiver 140 may include an antenna, an RF down converter, a demodulator, and an equalizer.

Further, in the same example, the broadcast processor 150 may include a demultiplexer, an RS decoder, and a deinterleaver. The demultiplexer of the broadcast processor 150 separates video data, audio data, and general data from the demodulated and equalized content. The RS decoder decodes the separated data, and the deinterleaver deinterleaves the decoded data using a preset interleaving rule to restore the video data, audio data, and general data. The display 110 may display the restored video data and general data. The audio data may be output through a speaker (not illustrated). The detailed configurations for signal transmission and reception by broadcasting standards are disclosed in their respective broadcasting standards document, the detailed illustration and explanation thereof will be omitted.

The receiver 160 is a component that receives a signal that is transmitted from a remote control device and a signal that is input through a button provided in a main body of the display apparatus 100, and transfers the received signal to the controller 120. The controller 120 may perform various operations according to the signals input through the receiver 160.

In the storage 170, various kinds of programs and data that are used in the display apparatus 100 may be stored.

The controller 120 may perform various operations using the programs stored in the storage 170. As an example, if the display apparatus 100 is turned on, the controller 120 may generate a main page that includes menus for various kinds of functions that can be provided by the display apparatus 100 and may display the generated main page on the display 110. In order to activate the use of the main page, the controller 120 may record the number of times the main page is used as usage history information.

In addition, the controller 120 may control the overall operation of the display apparatus 100 according to control commands for the display apparatus 100, and may store various kinds of information related to the usage history in the storage 170. For example, various kinds of usage history information, such as time measured from the turn-on of the display apparatus 100 to the turn-off thereof, content request contents and download information with respect to an IP server or other Video On Demand (VOD) system, content purchase amount, the number of SNS connections or connection time through the communicator 130, the number of communications with the server device 200 and communication time, the number of donation service winnings, and voice command usage records for controlling the operation of the display apparatus 100 using a voice command, may be stored in the storage 170.

Referring to FIG. 8, the controller 120 may include a RAM 121, a ROM 122, a CPU 123, a GPU 124, and a bus 125. Specifically, the controller 120 may be configured as a SoC (System on Chip) that includes the above-described components. Here, the RAM 121, the ROM 122, the CPU 123, and the GPU 124 may be connected to each other through the bus 125.

The CPU 123 accesses the storage 170 and performs booting using an operating system (O/S) stored in the storage 170. Further, the CPU 123 executes various kinds of programs stored in the storage 170 according to the control signal input through the receiver 160, and performs various operations using pre-stored content and data.

In the ROM 122, a command set for system booting is stored. If a turn-on command is input and the power is supplied, the CPU 123 copies the O/S stored on the storage 170 into the RAM 121 according to the command stored in the ROM 122, and boots the system through execution of the O/S. If the booting is completed, the CPU 123 copies various kinds of programs stored in the storage 170 onto the RAM 121, and performs various operations through execution of the programs copied onto the RAM 121. Such programs may include a program for extracting information of the currently viewed content, generating various kinds of additional information, such as area information and time information, and transmitting such information to the server device 200, a program for comparing content having the highest viewing rate among contents with the currently viewed content if information about the content having the highest viewing rate is received from the server device 200, and a program for controlling the GPU 124 to generate a GUI (Graphic User Interface) that indicates a UI object or viewing rate information according to the result of the comparison. The CPU 123 performs the operations as described above according to the various exemplary embodiments through execution of the programs.

The GPU 124 may display various screens under the control of the CPU 123. Specifically, if the server device 200 transmits a notification message, the GPU 134 may display the notification message in a proper position on the screen of the display 110 using an operator (not illustrated) and a renderer (not illustrated). The position of the notification message that is displayed on the screen may be variously set. For example, the position of the notification message may be at the edge of the screen, at a corner region of the screen, or at a center region of the screen. The operator sets attribute values, such as coordinate values on which respective objects are displayed, shapes, sizes, and colors of the objects according to the layout of the screen. The renderer generates a screen that includes the respective objects based on the attribute values set by the operator. The screen generated by the renderer is provided to and displayed on the display 110 to overlap the content being displayed.

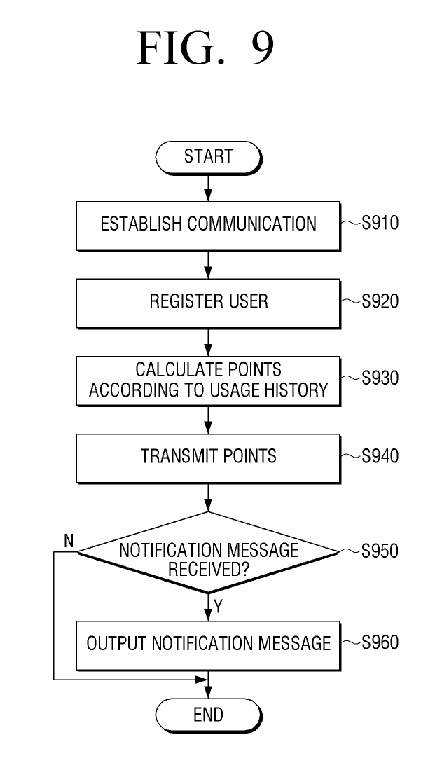

FIG. 9 is a flowchart illustrating a method for providing a service of a display apparatus according to an exemplary embodiment. Referring to FIG. 9, if communication with the server device 200 is established (S910), the display apparatus 100 may perform user registration. Specifically, the display apparatus 100 may display a screen for inputting user information, and transmit the user information that is input through the screen to the server device 200 to register the user information (S920).

In this state, the display apparatus 100 may directly calculate the points according to the usage history (S930) and may store the calculated points. If a preset time period arrives or a user command or a request from the server device 200 is input, the display apparatus 100 may transmit the points to the server device 200 (S940).

Thereafter, if the user of the display apparatus 100 wins a prize as a donor in the server device 200, the display apparatus 100 may receive a notification message from the server device 200. If the notification message is received (S950), the display apparatus 100 outputs the received notification message (S960).

In FIG. 9, it is exemplified that the display apparatus 100 directly calculates the points. However, the points may also be calculated by the server device 200 as described above.

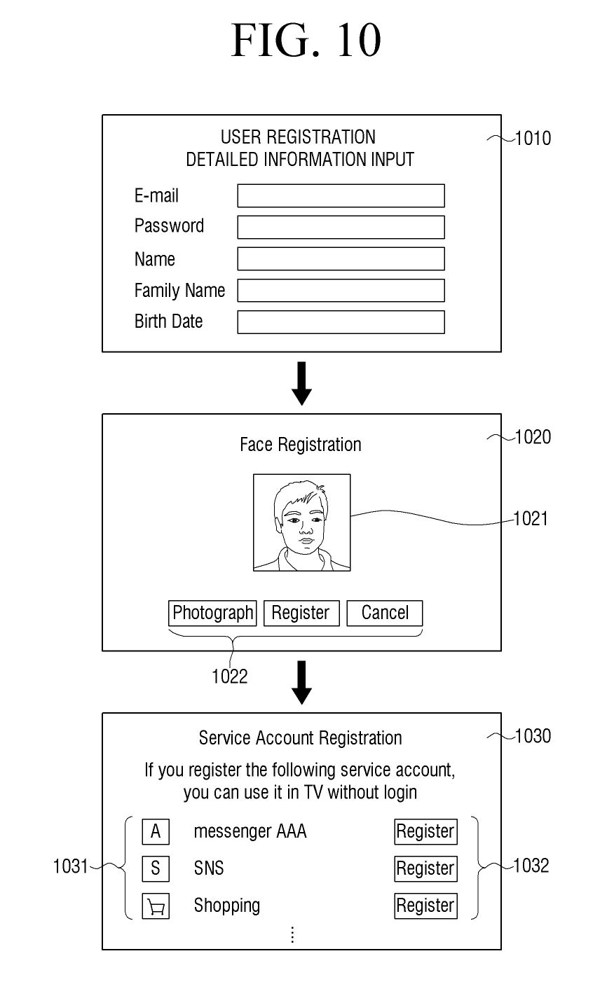

FIG. 10 is a diagram explaining an example of a user registration process. As described above, the display apparatus 100 may display the main page. In the main page, various kinds of menus including a user registration menu may be displayed. If the user selects the user registration menu, the display apparatus 100 displays a first screen 1010 on which a user can input detailed information. On the first screen 1010, an input region for inputting various kinds of personal information, such as an email, password, name, family name, and birth date, is displayed.

If all the personal information is input on the first screen 1010, the display apparatus 100 may display a second screen 1020 on which a user face can be registered. On the second screen 1020, a live view 1021 that is captured by a camera (not illustrated) provided in the display apparatus 100, and menus 1022 for photographing, photograph registration, and cancellation may be displayed.

If a photograph is registered on the second screen 1020, the display apparatus 100 may display a third screen 1030 on which a service to be registered in the server device 200 can be selected. On the third screen 1030, information 1031 on services that can be provided in association with an acquaintance or an external server, such as a messenger program, an SNS program, and a shopping program, and menus 1032 for registering the services may be displayed. If a service is registered on the third screen 1030, the user may only have to login to the display apparatus 100 to use the corresponding services through the display apparatus 100 without having to separately login to each of the corresponding services. That is, icons that correspond to the respective services are displayed on one side of the screen, and if a user selects an icon, the display apparatus 100 can immediately provide the corresponding service.

As described above, the user can input their personal information, that is, user information, through the screen that is divided into several pages. The display apparatus 100 may transmit at least one of input user information to the server device 200 to perform the user registration. Here, the email and the password may be used as identification information to log in to the server device 200.

Although not illustrated in FIG. 10, one of pages of the user registration screen may include a region on which a recipient can be directly input. That is, according to still another exemplary embodiment, the user may directly select a recipient in advance in the user registration process.

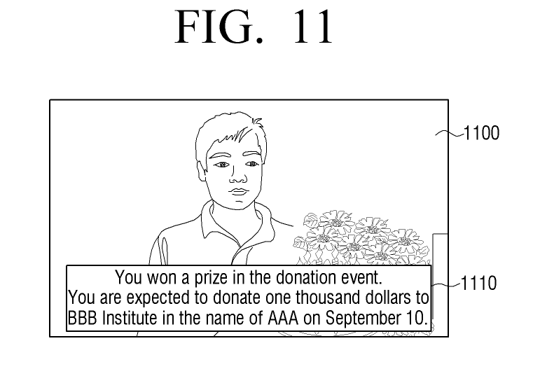

FIG. 11 is a diagram illustrating an example of a notification message that is displayed on a display apparatus 100 according to an exemplary embodiment. Referring to FIG. 11, a notification message may be expressed as a text message 1110 that is displayed at the edge portion of the screen 1100. The controller 120 may display the notification message 1110 at a preset position using the GPU 124.

The notification message may include the contents indicating that the donation is expected to be made in the donor's name, that is, in the name of the user of the display apparatus 100. In addition, as illustrated in FIG. 11, the notification message 1110 may include a donation date, recipient information, and donation amount, but is not limited thereto.

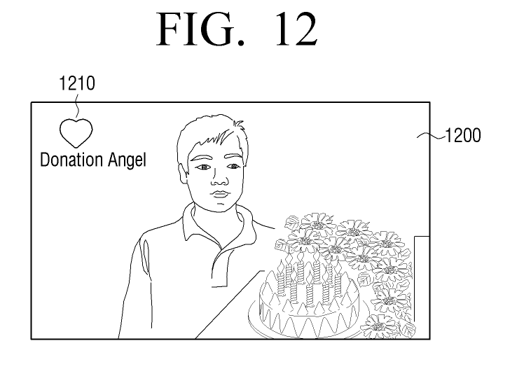

FIG. 12 is a diagram illustrating another type of a notification message. After the donation service is performed, a UI object 1210 indicating that the donation service has been executed may be displayed at a corner portion of the screen 1200 of the display apparatus 100. FIG. 12 illustrates that an icon type UI object 1210 is displayed, but the UI object 1210 may be displayed in various shapes, such as a photograph, text, and animation.

Accordingly, the server device 200 or the display apparatus 100 may periodically remind the user that the user has made the donation, and thus may encourage the user to make subsequent voluntary donation.

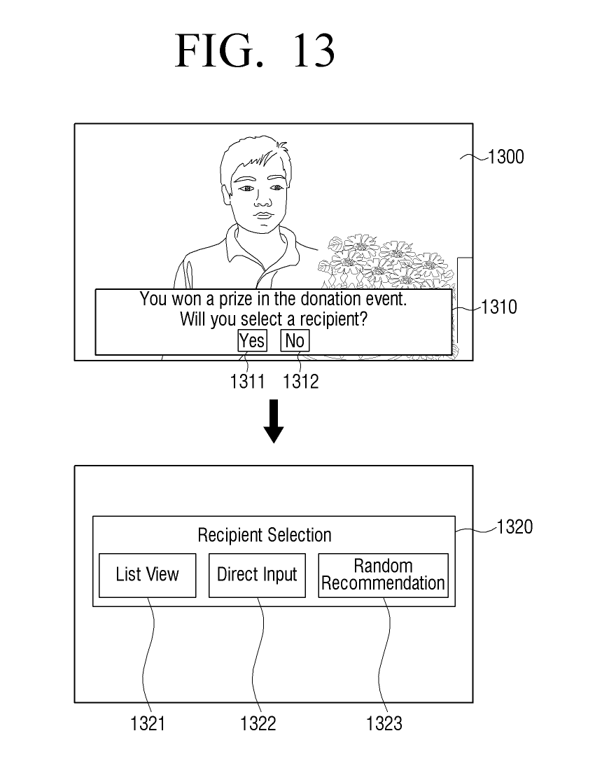

On the other hand, the donor may directly select the recipient as described above. FIG. 13 is a diagram explaining the operation of a display apparatus according to an exemplary embodiment in which a recipient can be selected.

Referring to FIG. 13, if a notification message is received, the display apparatus 100 displays a notification message 1310 in a screen 1300. In the notification message 1310, menus 1311 and 1312 for inquiring whether to directly select a recipient may be displayed.

Accordingly, if a user selects a menu 1311 for directly selecting the recipient, the display apparatus 100 displays a GUI 1320 for selecting a recipient using a selection method. On the GUI 1320, a first menu 1321 for selecting the recipient using a list, a second menu 1322 for directly writing recipient information, and a third menu 1323 for determination by random lottery may be displayed. Thereafter, the user may select a recipient through selection of a desired menu.

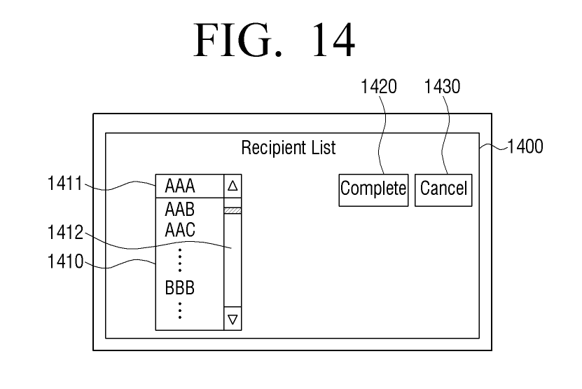

FIG. 14 is a diagram explaining the operation when the first menu 1321 is selected. Referring to FIG. 14, if the first menu 1321 is selected, the display apparatus 100 displays a GUI 1400 that includes a recipient list. In the GUI 1400, a recipient list 1410, a scroll bar 1412, a selection region 1411, and menus 1420 and 1430 may be displayed.

On the recipient list 1410, information about various recipient candidates registered in the server device 200 may be displayed. The user may select a recipient using the scroll bar 1412. The selected recipient is displayed on the selection region 1411. The user may select a completion menu 1420 in a state where the recipient is displayed on the selection region 1411. If the completion menu 1420 is selected, the controller 120 transmits the information about the selected recipient to the server device 200.

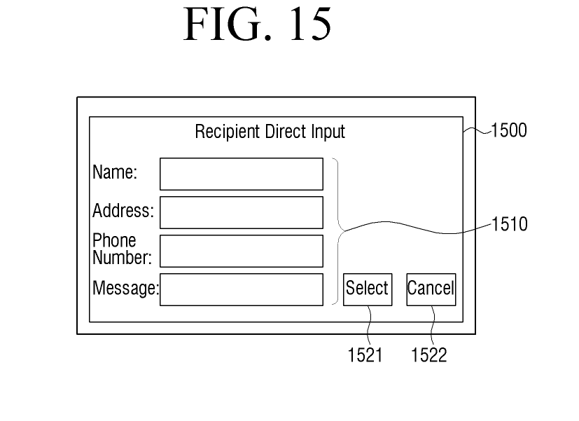

FIG. 15 is a diagram explaining the operation when the second menu 1322 is selected. Referring to FIG. 15, if the second menu 1322 is selected, the display apparatus 100 displays a GUI 1500 that includes a region 1510 on which various kinds of information can be input, and menus 1521 and 1522. The user may directly input the name of a recipient, an address, a phone number, and an aid message. In this case, the user may perform an input operation using a soft keyboard that is displayed on the screen of the display apparatus 100 or a button provided on a remote controller.

If the user selects a completion menu 1521 after the information is input, the controller 120 transmits the input recipient information to the server device 200.

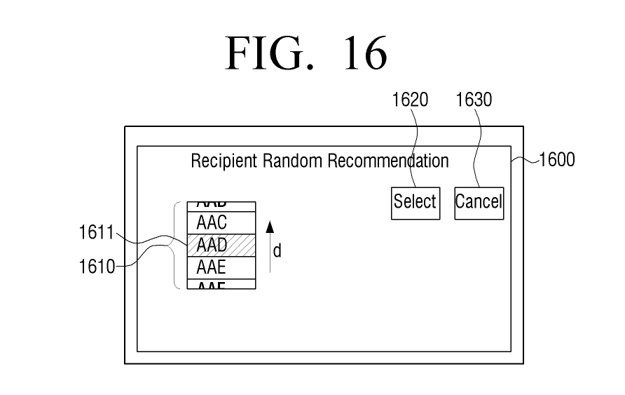

FIG. 16 is a diagram explaining the operation when the third menu 1323 is selected. Referring to FIG. 16, if the third menu 1323 is selected, the display apparatus 100 displays a GUI 1600. In the GUI 1600, a list 1610 on which recipients are randomly aligned, and menus 1620 and 1630 may be displayed. If the user selects the menu 1620 in a state where the list 1610 is scrolled at high speed like roulette, the scrolling speed is gradually decreased, and the list 1610 finally stops scrolling. Accordingly, a person who is finally displayed on a specific position 1611 in the list 1610 may be selected as a recipient.

In addition, the recipient may be selected using various other methods. For example, the display apparatus 100 may optionally recommend recipient candidates.

If the donation service is completed, the server device 200 may provide multimedia content, which is provided by the recipient who has received the donation, to the donor.

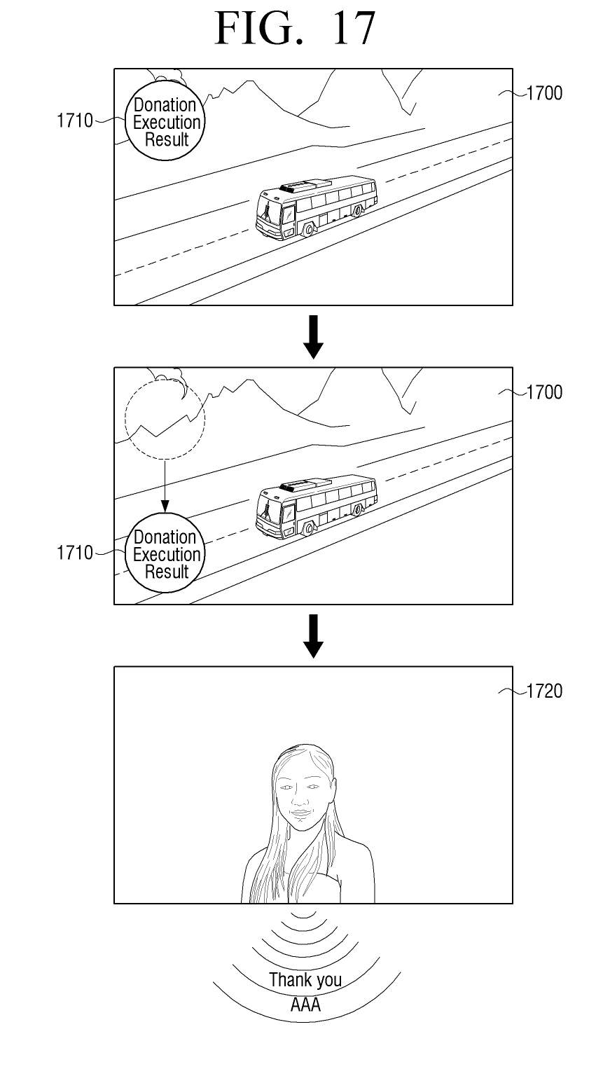

FIG. 17 is a diagram illustrating an example of a method for notifying a donor of a result of a donation.

Referring to FIG. 17, if the multimedia content is received through the communicator 130 of the display apparatus 100, the controller 120 displays a menu 1710 for confirming the result of the donation execution on one region in a screen 1700. The user may select the menu 1710 by directly touching the corresponding menu 1710 or using a remote controller or other main body buttons.

If the menu 1710 is selected, the controller 120 displays the received multimedia content 1720 through shifting of the screen 1700 as moving the display position of the menu 1710.

FIG. 17 shows a state where moving image content 1720, in which the recipient who has received the donation is speaking words of thanks, is displayed. As described above, since the user can receive a feedback of the result that is obtained through the use of the display apparatus, the user can obtain great satisfaction.

In addition to the multimedia content, the server device 200 may activate a subsequent donation through generation of a donation community related to the donation service.

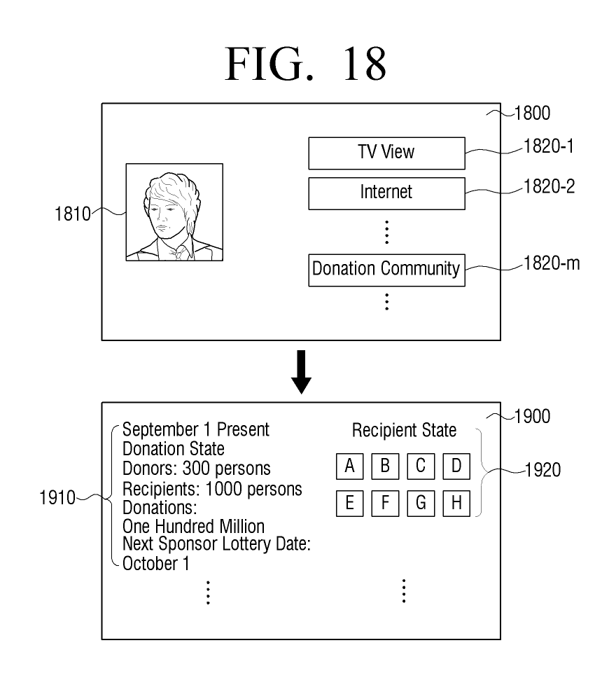

FIG. 18 is a diagram explaining a method for accessing a donation community and an example of the configuration thereof. Referring to FIG. 18, if the display apparatus 100 is turned on or if a user command is input, a main page 1800 may be displayed.

On the main page 1800, a broadcasting screen 1810 and various kinds of menus 1820-1 to 1820-m may be displayed. As described above, if the donation community is generated by the server device 200, a menu 1820-m for accessing the donation community may be displayed on the main page 1800 of the display apparatus 100.

If the user selects the corresponding menu 1820-m in this state, the display apparatus 100 accesses the server device 200. The server device 200 provides the main screen of the donation community to the display apparatus 100.

On the main screen 1900, various kinds of information, such as information 1910 related to the donation service and state information 1920 about donors and recipients, may be displayed.

Since the user can confirm the effects of user's donation services while viewing the donation community, more active subsequent donations can be encouraged.

As described above, the display apparatus 100 and the server device 200 can provide the donation service. Further, they can provide other various services in addition to the donation service.

The various service providing methods as described above may be implemented by program codes, and may be provided in a state where they are stored in a non-transitory computer readable medium. In the server device or the display apparatus, on which such a non-transitory readable medium is mounted, the service providing method according to various exemplary embodiments as described above may be executed through execution of the program codes.

The non-transitory computer readable medium refers to a device-readable medium which semi-permanently stores the data. For example, the above-described various applications or programs may be provided and stored in the non-transitory computer readable medium, such as a CD, a DVD, a hard disk, a Blu-ray disk, a USB, a memory card, and a ROM.

While the exemplary embodiments have been particularly shown and described, it will be understood by those skilled in the art that various changes in form and detail may be made therein without departing from the spirit and scope of the inventive concept, as defined by the appended claims.

What is claimed is:

1. A method for providing a service of a server device, the method comprising:
selecting a donor from among users registered in the server device;
selecting a recipient; and
in response to the donor and the recipient being selected, providing the donor with a notification message indicating that a donation service has been provided to the recipient in the name of the donor.

2. The method as claimed in claim 1, wherein the selecting the donor comprises selecting the donor based on a number of points that is calculated for each of the users registered in the server device, based on a usage history of each of the users registered in the server device.

3. The method as claimed in claim 2, wherein the selecting the donor further comprises:
receiving usage history information from a display apparatus of a user from among the users registered in the server device;
calculating the number of points based on the received usage history information; and
selecting the user as the donor in response to the number of points exceeding a threshold value.

4. The method as claimed in claim 2, wherein the selecting the donor further comprises:
receiving the number of points calculated by a display apparatus of a user from among the users registered in the server device; and
selecting the user as the donor in response to the number of points exceeding a threshold value.

5. The method as claimed in claim 2, wherein the usage history comprises at least one from among display apparatus usage results, usage results of a service provided by the server device, social networking service (SNS) usage results using the display apparatus, login frequency of the display apparatus, and login frequency of the server device.

6. The method as claimed in claim 1, wherein the selecting the donor comprises selecting the donor through a random lottery among the users registered in the server device.

7. The method as claimed in claim 1, further comprising requesting the donation service by transmitting information about the recipient and the donor to a donation execution institute.

8. The method as claimed in claim 1, further comprising providing the donor with multimedia content of the recipient after a preset time elapses, in response to the donation service being executed.

9. The method as claimed in claim 1, wherein the selecting the recipient comprises:
receiving information about the recipient which is input in a display apparatus of the donor; and
selecting the recipient based on the information about the recipient.

10. The method as claimed in claim 1, wherein the selecting the recipient comprises randomly selecting the recipient from among pre-registered recipients.

11. A server device comprising:
a communicator configured to perform communication with a display apparatus;
a storage configured to register a user of the display apparatus; and
a controller configured to select a donor from among users registered in the storage, and transmit, to the display apparatus of the donor, a notification message indicating that a donation service has been provided to a recipient in the name of the donor.

12. The server device as claimed in claim 11, wherein the controller is further configured to select the donor based on a number of points that is calculated for each of the registered users, based on a usage history of each of the registered users.

13. The server device as claimed in claim 12, wherein in response to usage history information being received from a display apparatus a user from among the registered users, the controller is further configured to calculate the number of points based on the received usage history information, and select the user as the donor in response to the number of points exceeding a threshold value.

14. The server device as claimed in claim 12, wherein the controller is further configured to receive the number of points calculated by a display apparatus of a user from among the registered users, and select the user as the donor in response to the number of points exceeding a threshold value.

15. The server device as claimed in claim 12, wherein the usage history comprises at least one from among display apparatus usage results, usage results of a service provided by the server device, social network service (SNS) usage results using the display apparatus, login frequency of the display apparatus, and login frequency of the server device.

16. The server device as claimed in claim 11, wherein the controller is further configured to select the donor through a random lottery among the registered users.

17. The server device as claimed in claim 11, wherein the controller is further configured to select the recipient, and
in response to the recipient being selected, the controller is further configured to request the donation service by transmitting information about the recipient and the donor to a donation execution institute.

18. The server device as claimed in claim 11, wherein in response to the donation service being executed, the controller is further configured to provide the donor with multimedia content of the recipient after a preset time elapses.

19. The server device as claimed in claim 11, wherein in response to information about the recipient input in a display apparatus of the donor being received, the controller is further configured to determine the recipient to receive the donation service according to the information about the recipient.

20. The server device as claimed in claim 11, wherein the controller is further configured to select the recipient by randomly selecting the recipient from among pre-registered recipients.

21. A method for selecting a donor and providing a donation service comprising:
receiving usage history information from a plurality of users registered in a server;
determining a number of points for each of the plurality of users, based on the received usage history information of the plurality of users;
selecting the donor from among the plurality of users, based on the determined number of points for each of the plurality of users; and
providing the donation service to a recipient in the name of the donor.
